(19) United States
(12) Patent Application Publication
(10) Pub. No.: US 2020/0306885 A1
(43) Pub. Date: Oct. 1, 2020

(54) METHODS FOR FORMING GRADIENT METALLIC BODIES VIA ADDITIVE MANUFACTURING

(71) Applicant: GM GLOBAL TECHNOLOGY OPERATIONS LLC, Detroit, MI (US)

(72) Inventors: Andrew C. Bobel, Troy, MI (US); Louis G. Hector, JR., Shelby Township, MI (US)

(21) Appl. No.: 16/371,520

(22) Filed: Apr. 1, 2019

(51) Int. Cl. B23K 26/342; B22F 3/105; B23K 26/02; B22F 1/00

(52) U.S. Cl. CPC B23K 26/342; B22F 3/1055; B33Y 10/00; B22F 1/0044; B22F 2207/17; B23K 26/02

(57) ABSTRACT

A method for forming a gradient metallic body can include forming a first metallic deposit by providing a first quantity of metal feedstock and selectively applying energy via an energy source to the first quantity of metal feedstock, and iteratively forming additional metallic deposits by providing an additional quantity of metal feedstock contiguous with a previously formed metallic deposit and selectively applying energy via the energy source to the additional quantity of metal feedstock. The energy applied via the energy source while forming the additional metallic deposits is iteratively varied such that the gradient metallic body is formed and comprises a first end, a second end, and a middle portion, wherein a material characteristic of the gradient metallic body transitions in the middle portion between the first end and the second end.

### INTRODUCTION

Additive manufacturing, also known as 3-D printing, refers to a process for creating a three-dimensional object through automated control by sequential layer material addition/joining within a three-dimensional work envelope. Objects can be manufactured in various shapes and geometries and can include sacrificial or support materials, enabling design shapes that were previously unachievable. Various additive manufacturing processes are known, differing primarily in the way that material layers are deposited and in materials used. In particular, additive manufacturing processes can include, for example, fused deposition modeling, laser sintering, electron beam melting, and inkjet 3D printing, using materials such as thermoplastic filaments, metal powders, plaster, resins, and concrete.

### SUMMARY

Provided are methods for forming gradient metallic bodies. The methods can include forming a first metallic deposit by providing a first quantity of metal feedstock and selectively applying energy via an energy source to the first quantity of metal feedstock, and iteratively forming additional metallic deposits by providing an additional quantity of metal feedstock contiguous with a previously formed metallic deposit and selectively applying energy via the energy source to the additional quantity of metal feedstock. The energy applied via the energy source while forming the additional metallic deposits can be iteratively varied such that the gradient metallic body is formed and includes a first end, a second end, and a middle portion, wherein a material characteristic of the gradient metallic body transitions in the middle portion between the first end and the second end. The metal feedstock can be a variable metal feedstock that varies in material composition as the additional metallic deposits are iteratively formed. The material characteristic can be a volumetric concentration of one or more elements, metallic microstructure, thermal conductivity, electrical conductivity, thermal expansion, heat capacity, porosity, strength, ductility, or fatigue resistance. The energy source can be a variable laser. The energy source can be a plurality of lasers. The energy source can be a laser configured to emit a laser beam with a wavelength of about 400 nm to about 1,200 nm with a power of about 20 Watts to about 1,000 Watts. The energy source can be varied according to a build plan. The energy source can be varied based on a measured reflectivity of the provided quantity of metal feedstock. The metal feedstock can be a variable metal feedstock that varies in material composition as it is provided to form successive metallic deposits.

Also provided are methods for forming a gradient metallic body. The methods can include forming a first metallic deposit by providing a first quantity of metal feedstock and selectively applying energy via at least one of a plurality of lasers to the first quantity of metal feedstock, and iteratively forming additional metallic deposits by providing an additional quantity of metal feedstock contiguous with a previously formed metallic deposit and selectively applying energy via the at least one of the plurality of lasers to the additional quantity of metal feedstock. The energy applied via the at least one of the plurality of lasers while forming the additional metallic deposits can be iteratively varied such that the gradient metallic body is formed and includes a first end, a second end, and a middle portion, wherein a material characteristic of the gradient metallic body transitions in the middle portion between the first end and the second end. The metal feedstock can be a variable metal feedstock that varies in material composition as the additional metallic deposits are iteratively formed. The material characteristic can be volumetric concentration of one or more elements, metallic microstructure, thermal conductivity, electrical conductivity, thermal expansion, heat capacity, porosity, strength, ductility, or fatigue resistance. At least one of the plurality of lasers can be a variable laser. The variable laser can be configured to selectively vary one or more of the wavelength and the power density output of its emitted laser beam. Each of the lasers can be configured to emit a laser beam with a wavelength which differs from the wavelength of a laser beam emitted by at least one other laser. The energy applied by the at least one of the plurality of lasers can be varied according to a build plan. The energy applied by the at least one of the plurality of lasers can be varied based on a measured reflectivity of the provided quantity of metal feedstock. The metal feedstock can be a variable metal feedstock that varies in material composition as it is provided to form successive metallic deposits.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a schematic view of an additive manufacturing process and system for fabricating a gradient metallic body, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the FIGURES can be combined with features illustrated in one or more other FIGURES to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Provided herein are for methods for forming components comprising gradient metallic bodies via additive manufacturing (AM). The methods utilize variable laser energy sources to iteratively form metal layers from metal feedstocks such that one or more material characteristics of the metal layers increasingly vary as the layers are formed. Variable laser AM systems also allow for faster and/or more energy efficient manufacturing of metallic bodies by tuning the wavelength of one or more laser beams to optimize the energy absorbed by the metal feedstock(s).

AM is a process by which a solid three-dimensional metallic structure is built layer-by-layer, typically where energy or heat is selectively applied to, and absorbed by, starting materials or feedstocks (e.g., in the form of powders or wires) to melt, consolidate, solidify, fuse, or sinter and create a layer of solid material. AM is often referred to synonymously with three-dimensional printing. Metal feedstocks may be used to create solid component structures via AM. Non-limiting examples of AM processes include powder bed fusion processes (e.g., laser sintering, laser melting, electron beam melting and selective heat sintering), direct metal deposition, fused deposition modeling, blown powder processes (e.g., directed energy deposition), wire-fed directed energy deposition (e.g., wire extrusion processes), liquid metal 3D printing systems, ultrasonic consolidation (e.g., via an ultrasonic energy source), and binder jetting, among others. Metal feedstocks can optionally include chemical or polymeric binders, in some embodiments.

A digital three-dimensional modeling system can be used to create a digital model, or build plan, of the component to be formed. The physical component can then be formed from the digital model by an AM system that creates solid fused structures in a layer-by-layer building process. The location and/or path that the energy source is applied to the metal feedstocks is defined by each respective cross-sectional layer of the three-dimensional product, for example as defined by the digital model thereof.

The application of energy to the metal feedstock effects alloying, phases changes, and/or compositional changes thereto. For example, a metal feedstock may include a mixture of unalloyed metals and the application of energy can produce an alloyed metal from the metal feedstock. In all AM processes, the intensity, application time, and/or application pattern of the energy source can be used to achieve particular material properties of the material layer formed from the metal feedstock.

In the case of powder bed fusion AM, for example, a thin layer of the powdered material is spread over a powder bed, and the energy source (e.g., a laser) is directed onto the powdered material to melt the powdered material where the laser is applied. The melted material solidifies, thereby forming a thin cross-sectional layer of a product. Another layer of the powdered material is spread over the previously formed layer, and the energy source is directed onto the powdered material to melt the powdered material and fuse it with the underlying layer where the laser is applied. The melted material solidifies, thereby forming a slightly thicker cross-sectional layer of the product. The process is repeated until the entire three-dimensional product is formed.

In the case of direct metal laser sintering (DMLS) AM, for example, a rapid high energy delivery method is used to directly melt metal powder in layers. After applying laser energy and locally melting the feedstock material, the process is followed by rapid cooling, as the beam moves on to process contiguous feedstock materials. DMLS provides local, rapid high energy deposition. Only a few milligrams of feedstock material are heated at a given time (e.g., with a predetermined range of time, such as a few milliseconds (e.g., less than about 3-5 ms) of processing). The rapid cooling to underlying layers is typically a non-equilibrium process, and is designed to create large, directional thermal gradients and large local strain.

The metal feedstocks used in AM can include metals, such as aluminum alloys (e.g., AlSi₁₀Mg, AlSi₁₂), copper alloys, nickel alloys, titanium alloys (e.g., Ti₆Al₄V), cobalt chromium alloys (e.g., ASTM F75), austentitic nickel chromium alloys, steel alloys, including automotive steels, stainless steels (e.g., 316L, 17-4 PH, and 15-5 PH), maraging steels, and structural steels (e.g., HSLA 420, 4140), among many other metal feedstocks. In general, the methods provided herein may utilize any suitable metal feedstocks as would be identified as suitable by one of skill in the art.

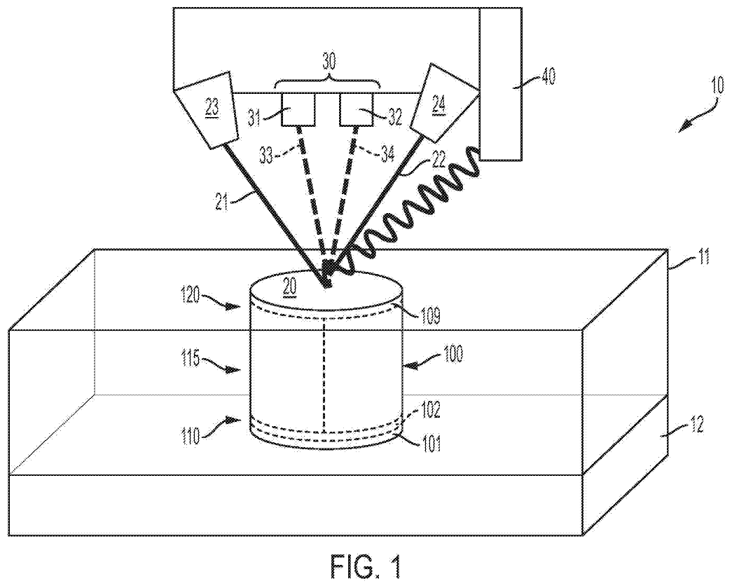

In a non-limiting example of AM, an illustration of a direct energy deposition process and system 10 for fabricating a metallic body 100 is shown in FIG. 1 as an example of a suitable AM approach. System 10 can be used to build the three-dimensional metal alloy body 100 layer by layer (e.g., microlayer by microlayer) from one or more metal feedstocks 20, such as metal feedstocks 21 and 22, described herein or known in the art. System 10 generally includes a printing chamber 11 that surrounds a build plate 12. The printing chamber 11 can comprise an enclosure, as shown, or generally refer to the area in which AM occurs. Metal feedstock 20, such as metal feedstocks 21 and 22, can be supplied, from respective reservoirs 23 and 24, for example, to the printing chamber 11. It is understood that reservoirs 23 and 24 may be disposed at various positions throughout the system 10, and the mode of metal feedstock 20 delivery may vary based on the type of AM employed by the system 10. Furthermore, it is understood that metal feedstock 20 includes a plurality of feedstocks (e.g., 3, 4, 5, etc. feedstocks) and is not limited to the two metal feedstocks 21 and 22 as shown. An energy source 30 can selectively apply energy to metal feedstock 20 within the printing chamber 11.

As shown, a gradient metallic body 100 can be fabricated by AM by forming a first metallic deposit 101 by providing a first quantity of metal feedstock 20 and selectively applying energy via energy source 30 to the first quantity of metal feedstock 20. After energy is applied to sinter or melt the metal feedstock, the metal feedstock rapidly cools and solidifies into a metallic deposit (e.g., a microlayer). Once the first metallic deposit 101 is formed, additional metallic deposits 102, 109 can be iteratively formed by providing an additional quantity of metal feedstock 20 contiguous with a previously formed metallic deposit and selectively applying energy via the energy source 30 to the additional quantity of metal feedstock 20. Each successively formed metallic deposit, upon solidification and/or cooling, fuses to the previously formed metallic deposit. As the additional metallic deposits are iteratively formed, the energy applied via the energy source 30 while forming the additional metallic deposits is iteratively varied such that a material characteristic of the additional metallic deposits generally increasingly varies from the first metallic deposit 101. Accordingly, the gradient metallic body 100 comprises a first end 110, a second end 120, and a middle portion 115, wherein a material characteristic of the gradient metallic body 100 transitions in the middle portion 115 between the first end 110 and the second end 120.

The energy source 30 can comprise one or more lasers 31 and 32 configured to apply energy to metal feedstock 20 within the printing chamber 11. In one embodiment, the laser(s) 31, 32 can comprise a variable wavelength laser capable of changing the wavelength of the laser beam emitted thereby. For example, the laser can be configured to emit a laser beam with a wavelength of about 400 nm to about 1,200 nm with a power, or intensity, of about 20 Watts to about 1,000 Watts. Some such lasers can have an intensity of about 200 watts to about 500 watts. In another embodiment, the energy source 30 can comprise a plurality of lasers, such as lasers 31 and 32, configured to emit a laser beam of a certain wavelength which differs from the wavelength of the laser beam emitted by at least one other laser. For example, such lasers can be configured to emit a fixed or variable laser beam with a wavelength within the range of about 400 nm to about 1,200 nm with a power of about 20 Watts to about 1,000 Watts, or about 200 watts to about 500 watts. In one embodiment wherein a plurality of lasers are utilized, each of the lasers can be configured to emit a laser beam with a fixed or variable wavelength which differs from the wavelength of the laser beam emitted by at least one other laser.

The energy source 30 can be varied according to a build plan. In the case of an energy source 30 that comprises a variable laser, a build plan can be referenced that dictates the wavelength of the laser beam applied to the quantity of metal feedstock 20 for a given deposit (e.g., deposit 102). As used herein, a variable laser refers to a laser which can selectively vary the wavelength and/or the power density output of its emitted laser beam. In the case of an energy source 30 that comprises a plurality of lasers, a build plan can be referenced that dictates which laser beam(s) are to apply energy to the quantity of metal feedstock 20 for a given deposit (e.g., deposit 102). The power of the laser(s) may additionally or alternatively be varied, in either embodiment, per the build plan.

In another embodiment, the energy source 30 is varied based on a measured reflectivity of the provided quantity of metal feedstock 20. The reflectivity can be measured by an in-situ reflectivity sensor 40, for example. For example, the reflectivity of the quantity of metal feedstock 20 provided to the printing chamber can be measured, and the laser wavelength and/or intensity can be selected from a lookup table or formula based on the measured reflectivity. The reflectivity of the metal feedstock can be measured while energy is applied thereto via the energy source 30, and the wavelength and/or intensity of the laser can be adjusted while applying energy to a particular metallic deposit.

In some embodiments, the metal feedstock can comprise a single material of a fixed composition. In other embodiments, the metal feedstock can comprise a variable metal feedstock that varies in material composition as it is provided to form successive metallic deposits. In such an embodiment, the variable metal feedstock can comprise a variable mixture of a plurality of metal powders, a plurality of metallic wires, or an alloyed gradient metallic wire. When the variable metal feedstock comprises a plurality of metal powders or metallic wires, the plurality of powders or wires can be metered to the printing chamber 11 at different rates such that the desired gradient material characteristic of the metallic body 100 is achieved.

When a fixed composition metal feedstock is utilized, the material characteristic of the metallic body 100 which defines the gradient can comprise, for example, metallic microstructure, thermal conductivity, electrical conductivity, thermal expansion, heat capacity, porosity, strength, ductility, fatigue resistance, and combinations thereof. When a variable metal feedstock is utilized, the material characteristic of the metallic body 100 which defines the gradient can comprise volumetric concentration of one or more elements, metallic microstructure, thermal conductivity, electrical conductivity, thermal expansion, heat capacity, porosity, strength, ductility, fatigue resistance, and combinations thereof.

Varying the energy source 30 can comprise varying the wavelength and/or intensity of one or more lasers. In general, the wavelength of a laser can be tuned to maximize energy absorption by a metal feedstock 20. Further, the wavelength can be tuned to achieve a desired effect on the metal feedstock. The wavelength and intensity of one or more lasers can be cooperatively varied to impart a desired energy to a metal feedstock 20. For example, a laser can impart a given amount of energy to a metal feedstock 20 by operating at a first wavelength optimized for maximize absorption at a first intensity, or the laser can impart the same amount of energy by operating at a second wavelength which is less optimally absorbed by the metal feedstock 20 and an increased intensity.

A gradient metallic body 100 can comprise iron and copper, wherein the gradient can be defined by the material characteristics of the volumetric concentrations of iron and copper and thermal conductivity, wherein the copper-rich end of the gradient metallic body 100 with higher volumetric concentrations of copper relative to iron exhibits higher thermal conductivity than the iron-rich end of the gradient metallic body 100. The gradient can be achieved by iteratively varying the laser wavelength used to form the copper-rich metallic deposits at a first end of the body 100 from one which couples well with copper (about 400 nm to about 500 nm, or about 450 nm) to a laser wavelength used to form the iron-rich metallic deposits at a second end of the body 100 which couples well with iron (about 950 nm to about 1,050 nm, or about 1,000 nm). In this embodiment, “the first end” and “the second end” can refer to either the first end 110 or the second end 120 as depicted in FIG. 1.

A gradient metallic body 100 can comprise two aluminum alloys (e.g., Alloy 1: a 7xxx aluminum alloy, and Alloy 2: a 2xxx series alloy with higher copper content relative to Alloy 1) wherein the gradient can be defined by the material characteristics of the volumetric concentrations of the aluminum alloys, strength, and ductility, wherein the Alloy 1-rich end of the gradient metallic body 100 with higher volumetric concentrations of Alloy 1 relative to Alloy 2 exhibits higher strength and lower ductility than the Alloy 2-rich end of the gradient metallic body 100. The gradient can be achieved by forming Alloy 1-rich metallic deposits at a first end of the body 100 using a laser wavelength of about 810 nm or about 800 nm, and iteratively decreasing the laser wavelength used to form successive metallic deposits such that a gradient body 100 is formed comprising an Alloy 2-rich second end. In this embodiment, “the first end” and “the second end” can refer to either the first end 110 or the second end 120 as depicted in FIG. 1.

A gradient metallic body 100 can comprise iron and nickel, wherein the gradient can be defined by the material characteristics of the volumetric concentrations of iron and nickel and thermal expansion and coke resistance, wherein the iron-rich end of the gradient metallic body 100 with higher volumetric concentrations of iron relative to nickel exhibits lower thermal expansion and lower coke resistance than the nickel-rich end of the gradient metallic body 100. The gradient can be achieved by iteratively varying the laser wavelength used to form the iron-rich metallic deposits at a first end of the body 100 from one which couples well with iron (about 990 nm to about 1,010 nm, or about 1,000 nm) to a laser wavelength used to form the nickel-rich metallic deposits at a second end of the body 100 which couples well with nickel (less than about 550 nm, or less than about 530 nm). In this embodiment, “the first end” and “the second end” can refer to either the first end 110 or the second end 120 as depicted in FIG. 1.

A gradient metallic body 100 can comprise aluminum, wherein the gradient can be defined by the material characteristics of porosity. The gradient can be achieved by iteratively varying the laser wavelength used to form the lower porosity first end of the body 100 from one which couples well with aluminum (about 790 nm to about 810 nm, or about 800 nm) to a laser wavelength used to form the higher porosity deposits at a second end of the body 100 which couples less well with aluminum (about 990 nm to about 1,010 nm, or about 1,000 nm). As the wavelength of the laser is varied to reduce coupling compatibility with aluminum, incomplete melting of aluminum feedstocks (e.g., powder) will create increased porosity. The final wavelength used to form the metallic deposits at the second end 120 of the body 100, and throughout the material gradient, can be tailored based on the desired porosity. In this embodiment, “the first end” and “the second end” can refer to either the first end 110 or the second end 120 as depicted in FIG. 1.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for forming a gradient metallic body, the method comprising:
forming a first metallic deposit by providing a first quantity of metal feedstock and selectively applying energy via an energy source to the first quantity of metal feedstock; and
iteratively forming additional metallic deposits by providing an additional quantity of metal feedstock contiguous with a previously formed metallic deposit and selectively applying energy via the energy source to the additional quantity of metal feedstock, wherein the energy applied via the energy source while forming the additional metallic deposits is iteratively varied such that the gradient metallic body is formed and comprises a first end, a second end, and a middle portion, wherein a material characteristic of the gradient metallic body transitions in the middle portion between the first end and the second end.

2. The method of claim 1, wherein the material characteristic comprises metallic microstructure, thermal conductivity, electrical conductivity, thermal expansion, heat capacity, porosity, strength, ductility, or fatigue resistance.

3. The method of claim 1, wherein the metal feedstock comprises a variable metal feedstock that varies in material composition as the additional metallic deposits are iteratively formed.

4. The method of claim 3, wherein the material characteristic comprises volumetric concentration of one or more elements, metallic microstructure, thermal conductivity, electrical conductivity, thermal expansion, heat capacity, porosity, strength, ductility, or fatigue resistance.

5. The method of claim 1, wherein the energy source comprises a variable laser.

6. The method of claim 1, wherein the energy source comprises a plurality of lasers.

7. The method of claim 1, wherein the energy source comprises a laser configured to emit a laser beam with a wavelength of about 400 nm to about 1,200 nm with a power of about 20 Watts to about 1,000 Watts.

8. The method of claim 1, wherein the energy source is varied according to a build plan.

9. The method of claim 1, wherein the energy source is varied based on a measured reflectivity of the provided quantity of metal feedstock.

10. The method of claim 1, wherein the metal feedstock comprises a variable metal feedstock that varies in material composition as it is provided to form successive metallic deposits.

11. A method for forming a gradient metallic body, the method comprising:
forming a first metallic deposit by providing a first quantity of metal feedstock and selectively applying energy via at least one of a plurality of lasers to the first quantity of metal feedstock; and
iteratively forming additional metallic deposits by providing an additional quantity of metal feedstock contiguous with a previously formed metallic deposit and selectively applying energy via the at least one of the plurality of lasers to the additional quantity of metal feedstock, wherein the energy applied via the at least one of the plurality of lasers while forming the additional metallic deposits is iteratively varied such that the gradient metallic body is formed and comprises a first end, a second end, and a middle portion, wherein a material characteristic of the gradient metallic body transitions in the middle portion between the first end and the second end.

12. The method of claim 11, wherein the material characteristic comprises metallic microstructure, thermal conductivity, electrical conductivity, thermal expansion, heat capacity, porosity, strength, ductility, or fatigue resistance.

13. The method of claim 11, wherein the metal feedstock comprises a variable metal feedstock that varies in material composition as the additional metallic deposits are iteratively formed.

14. The method of claim 13, wherein the material characteristic comprises volumetric concentration of one or more elements, metallic microstructure, thermal conductivity, electrical conductivity, thermal expansion, heat capacity, porosity, strength, ductility, or fatigue resistance.

15. The method of claim 11, wherein at least one of the plurality of lasers is a variable laser.

16. The method of claim 15, wherein the variable laser is configured to selectively vary one or more of a wavelength and a power density output of its emitted laser beam.

17. The method of claim 11, wherein each of the lasers is configured to emit a laser beam with a wavelength which differs from the wavelength of a laser beam emitted by at least one other laser.

18. The method of claim 11, wherein the energy applied by the at least one of the plurality of lasers is varied according to a build plan.

19. The method of claim 11, wherein the energy applied by the at least one of the plurality of lasers is varied based on a measured reflectivity of the provided quantity of metal feedstock.

20. The method of claim 11, wherein the metal feedstock comprises a variable metal feedstock that varies in material composition as it is provided to form successive metallic deposits.
